(19) United States
(12) Patent Application Publication
(10) Pub. No.: US 2017/0323549 A1
(43) Pub. Date: Nov. 9, 2017

(54) SYSTEM AND METHOD FOR REMINDING A USER THAT AN INFANT IS ON BOARD A VEHICLE

(71) Applicant: Joy COPULOS, Bedford, NY (US)

(72) Inventor: Joy COPULOS, Bedford, NY (US)

(21) Appl. No.: 15/587,012

(22) Filed: May 4, 2017

Related U.S. Application Data
(63) Continuation of application No. 62/331,480, filed on May 4, 2016.

(51) Int. Cl. G08B 21/02; B60Q 9/00

(52) U.S. Cl. CPC G08B 21/0202; B60Q 9/00

(57) ABSTRACT

A system for reminding a user of an infant's presence is disclosed. The system features a memory that stores computer-executable instructions and a processor which is communicatively coupled to said memory. The processor is used to facilitate the execution of the computer-executable instructions. These instructions include at least one reminder of the infant's presence, the identity of a primary individual to receive at least one reminder; at least one period of time to commence the sending of a notification, an interval period of time, among others.

### CLAIM OF PRIORITY

This application is a non-provisional patent application and claims priority to U.S. provisional patent application No. 62/331,480, filed on May 4, 2016, incorporated herein in its entirety.

### FIELD OF THE EMBODIMENTS

The invention and its embodiments relate to a system and method for reminding a user that a child or infant is on board of a vehicle.

### BACKGROUND OF THE EMBODIMENTS

Each year, dozens of children are killed due to heat stroke from being left in a car on a hot summer day. Despite these occasions being plastered on the news and the formation of a number of child-car safety coalitions, the incidence of these accidents stays relatively stagnant year-over-year. This seems bizarre due to the potentially-tragic outcomes that can occur.

While in rare instances, these children entered the car on their own, there are also the incidents where a child is inadvertently left in a car while their caretaker steps away to do some task. Frequently the tasks takes longer than the caretaker expected, and the child is left in the car for a period of time, however, almost as frequently the caretaker genuinely forgets about the child in the car, and then goes about their tasks without any sort of immediacy. This laisse-faire attitude is not adopted with any malicious intent, merely with a pang of forgetfulness. Very frequently parents of children, ranging from infant children to pre-teens, as well as the owners of pets, can be both tired and distracted, which can lead to an inadvertent abandoning of a child or pet in the car.

Further confounding this problem is that despite the highly-interconnected world that exists today, there are no tools that enable a forgetful caregiver to receive reminders from a friend or other third party. Despite numerous PSA's, and a number of existing systems, there has yet to be a solution that enables a caretaker to quickly set a reminder that can be seen by a number of people.

Examples of related art are as follows:

U.S. Pat. No. 6,812,844 pertains to a child safety seats with alarms notify the driver of a vehicle that an infant is in its carrier inside of the vehicle when a door is opened. Forgetting a child inside of the vehicle can result in severe injury to or the death of the child from extreme temperature conditions and/or dehydration. Child safety seats with alarms not only protect the child in the event of accident, but also detect the opening of a vehicle door and remind the driver of the presence of the child through visual and audio alerts. The detector and alarm system are automatically engaged when the buckle of the child safety seat is closed. The condition of the batteries powering the detector and alarm system are also monitored so that the user can be confident that the detector and alarm system have adequate power to function. A pressure transducer is employed as a detector to sense the changing air pressure caused by the opening or closure of a vehicle door. When such a condition is detected, red LEDs light up and an alarm is sounded from a speaker.

U.S. Pat. No. 7,265,671 pertains to an alarm system for use with a motor vehicle to sound an alert whenever child passengers are left unattended and belted in a parked motor vehicle, including a transmitter for generating a radio signal characterized by a predetermined frequency, a receiver for receiving and rectifying the radio signal, a sensor for sending an ignition status signal to the receiver if the vehicle ignition is on, a timer for sending an activation signal in response to the receiver receiving the radio message and the ignition status signal, and an alarm for generating an audible signal in response to receipt of the activation signal.

U.S. Pat. No. 7,378,974 pertains to a child seat safety system for alerting a person to a child buckled in a vehicle safety seat. The child seat safety system includes a main controller for attachment to the vehicle safety seat. At least one alerting device having at least one lighting device is provided in signal-receiving relationship to the main controller for activation by the main controller while the child remains in the vehicle safety seat.

U.S. Pat. No. 7,378,979 pertains to a system for detecting the presence of a child in a car, when the driver exits the vehicle. A sensor is connected to the seat belt of the baby's car seat or to the rear seat belts. Once the seat belt is inserted into the belt buckle, an alarm circuit is activated. When the driver enters the vehicle and sits down, the system detects the presence of the driver and de-activates the alarm circuit. When the driver exits, the alarm circuit is then re-activated. The system includes a delay timer that gives the driver time to enter and exit the vehicle without setting off the alarm circuit. When the alarm circuit is activated, a timer for the time delay begins. At the end of the time delay (e.g., relay is transferred), if the driver has not disabled the alarm circuit by re-entering the vehicle or taking the child out of the vehicle, the alarm circuit will be set off warning signals and will remain energized until disabled.

U.S. Pat. No. 7,408,445 pertains to an alarm that detects the presence of individuals seated in the rear of the vehicle, and upon detection of which shall emit an alarm, provided the vehicle is turned off. The alarm system includes pressure sensors that are integrated into the rear seats of a vehicle, and which are in wired communication with a central processing unit located elsewhere within said vehicle. The central processing unit is further in wired communication with a timer, vehicle lights, and a vehicle battery in order to operate, sense, and emit an alarm upon detection that individuals remain in any of the rear seats while the vehicle is parked.

U.S. Pat. No. 7,466,217 pertains to system for signaling that a person is in an vehicle is provided and includes a power source, a processing unit including a counter, a state monitoring unit configured to monitor an internal temperature of the vehicle and to monitor whether the vehicle is in an off state and a door monitoring unit configured to monitor whether any of the vehicle doors are open or closed, a first buckle receiver, including a first signal issuing unit, a first buckle to be removably inserted into the buckle receiver and to thereby cause the first signal issuing unit to issue an installation signal to the processing unit, a second buckle receiver, including a second signal issuing unit, a second buckle to be removably inserted into the second buckle receiver and to thereby cause the second signal issuing unit to issue an occupation signal to the processing unit, and an alarm unit.

U.S. Pat. No. 8,378,801 pertains to a system for determining abandonment of a child or infant in a vehicle. The system features a remote key in communication with sensors operatively connected to seatbelts in a vehicle. If a user presses the lock button on the remote key the sensors determine if any seatbelt has been left engaged. If a seatbelt is engaged an alarm is activated on the remote key. If no seatbelt is left engaged, the vehicle doors become locked. To override the alarm, and override button must be pushed on the remote key. An unlock button on the remote key unlocks the vehicle doors and the system is reset.

U.S. Pat. No. 8,892,302 pertains to a driver reminder system to remind at least the driver of a vehicle, prior to leaving such vehicle, that there is at least one other occupant in the vehicle. The system couples to after-market and OEM vehicle alarm systems to provide vehicle alerting of a child left in the vehicle.

United States Patent Publication No. 2003/0062996 pertains to a weight-sensitive mat or other sensor determines whether a child seat in a vehicle is occupied, a transmitter is proximate to the sensor, and a keychain fob or other portable unit includes a receiver and an alarm. Generally, if the child seat is occupied and the keychain fob is removed from proximity to the transmitter, the transmitter communicates this to the keychain fob receiver and the alarm is activated. Exemplary embodiments include an add-on kit including a base unit with a transceiver for use with existing car seats having a base and a detachable shell, an add-on kit without the base unit for use with existing unitary car seats, and a car seat with the child sensor, transmitter, and/or base unit built into it.

United States Patent Publication No. 2003/0098792 pertains to a system and method uses a wireless tether comprising a transmitter and a receiver to alert a caregiver that an object or person has been left unattended. A detector senses the presence of the object, usually a child, located in a position such as a safety seat. The detector couples to the transmitter, which is located near the object. The transmitter transmits at least one wireless signal when the object is in the position. The receiver, which is remotely located from the transmitter, senses the at least one signal as long as the receiver is within a prescribed range of transmission. By performing a timing function, the receiver monitors the proximity of the caregiver, who maintains possession of the receiver, to the transmitter. The system communicates an alarm to the caregiver when the caregiver ventures outside the range of transmission without having removed the object/child from the position.

United States Patent Publication No. 2004/0113797 pertains to a method of monitoring the presence of an occupant in a passenger compartment of a moving vehicle having an operating engine with on and off states. The method includes the steps of: providing a sensing system on the moving vehicle which detects the presence of an occupant in the passenger compartment of the moving vehicle; providing a detectable signal generator; and causing the detectable signal generator to generate a detectable signal in the event that at least one of a) the temperature in the passenger compartment changes to above or below a predetermined temperature with the sensing system detecting the presence of an occupant in the passenger compartment of the moving vehicle, b) the operating engine is in the off state with the sensing system detecting the presence of an occupant in the passenger compartment of the moving vehicle, c) a user exits from the vehicle with the sensing system detecting the presence of an occupant in the passenger compartment of the moving vehicle, and d) the operating engine is changed from the on state to the off state with the sensing system detecting the presence of an occupant in the passenger compartment of the moving vehicle.

United States Patent Publication No. 2005/0099285 pertains to a device that reminds drivers that babies and/or small children are still in the backseats of their vehicles. This is similar to current front seatbelt alarms in design except that instead a warning device when seatbelts are NOT fastened, a reminder of sound/light occurs when the back seatbelts are left locked. There is more than one way this could be designed. It could use the same warning circuitry as the headlights when they are left on after the ignition is turned off. Another way would be to use the vehicle's alarm system.

United States Patent Publication No. 2007/0090938 pertains to an infant seat alarm system to both detect and alert the presence of an unattended infant in a vehicle comprises an infant seat having a sensor and a detector seat having a second sensor. The sensor is coupled to the second sensor and both sensors are coupled to a timer device. A power supply independent of a power supply of the vehicle powers the timer device. One or more alarms are coupled to the timer device. After a predetermined time the timer device actuates at least one of the alarms to emit an audible sound if the infant seat is occupied by an infant and the detector seat is unoccupied by a person. An external alarm may be coupled to the timer device. Additionally a switch operable by a person may be coupled to both the timer device and the sensor of the infant seat.

United States Patent Publication No. 2008/0055064 pertains to a safety system that reminds parents when their children are still strapped inside the car. The preferred system monitors the status of the driver's seatbelt buckle and the child's buckle, and includes at least two different alarms. The first alarm, which is not offending and can only be heard inside the Vehicle, is sounded after the driver unbuckles and the child remains buckled in the car. The second alarm, which is louder than the first and can be heard outside the vehicle, is sounded after a set amount of time has expired since the driver unbuckled, and yet the child remains buckled in the car. The second alarm is intended to draw the attention of members of the public, and on a hot day could save the child's life.

United States Patent Publication No. 2012/0007741 pertains to an apparatus for warning a driver of a car that a child, pet or valuable is still in the car when an attempt is made by the driver to lock the car doors after the car is parked and the engine is turned off comprising a keyless remote entry device having a door unlocking button and a door locking button; at least one button on the keyless remote entry device which, when first pressed, shows that a child, pet or valuable is being placed in the car; a control circuit coupled to the keyless remote entry device; and an alarm circuit controlled by the control circuit; wherein the keyless remote entry device cannot be used to lock the car doors when a child, pet or valuable is still in the car after the car engine is turned off and the button has not been pressed a second time to alert the remote entry device that the child, pet or valuable has been removed from the car.

United States Patent Publication No. 2012/0232749 pertains to systems and methods which provide for an alarm or notification that a child is in a car seat. The systems generally determine if a child is in the seat and that the seat, and therefore the vehicle, is not in motion. Upon detecting both situations, the notification or alarm is activated. The system will generally provide for an alarm to a smartphone or other remote notification device to improve the likelihood that the alarm will be received.

United States Patent Publication No. 2013/0049946 pertains to a vehicle occupant detection and alerting system comprising a vicinity motion detector capable sending a wireless transmission and a transmission receiving means capable of receiving the motion detector's wireless transmission and triggering a vehicle alarm system, vehicle horn, a mobile device or other form of notification if a child is left unattended in a vehicle.

United States Patent Publication No. 2014/0091925 pertains to a two component system for ensuring persons (such as infants), objects or animals are not unintentionally left unattended in parked cars. The system requires the driver (custodian) to activate a first component that emits a radio signal. The radio signal is received by a second component. The second component may be attached to the custodian's ignition key chain. The radio signal has limited range. If the custodian walks away from the car or first transmitting component without first disabling the first component, an alarm will illuminate or sound. The system may also be used with other devices such as shopping carts. It may also be used to monitor movement of disabled individuals.

United States Patent Publication No. 2014/0184404 pertains to systems and methods which provide for an alarm or notification that a child is in a car seat. The systems generally determine if a child is in the seat and that the seat, and therefore the vehicle, is not in motion. Upon detecting both situations, the notification or alarm is activated. The system will generally provide for an alarm to a smartphone or other remote notification device to improve the likelihood that the alarm will be received.

Various devices are known in the art. However, their structure and means of operation are substantially different from the present invention. Such devices fail to provide a device that is optimized for multiple extremities, is intended to be easily portable, contains no mechanical parts, and is intended for at-home use and in medical facilities. At least one embodiment of this invention is presented in the drawings below, and will be described in more detail herein.

### SUMMARY OF THE EMBODIMENTS

The present invention discloses a system for reminding of an infant's presence comprising: a memory that stores computer-executable instructions; and a processor, communicatively coupled to said memory that facilitates execution of the computer-executable instructions, the instructions of which comprises: receiving, via a processor, an instruction to commence at least one reminder of the infants presence; receiving, via a processor, the identity of a primary individual to receive at least one reminder; wherein the at least one reminder comprises at least one of plurality of notifications; receiving, via a processor, at least one of a selected time period to commence the at least one of the plurality of notifications; receiving, via a processor, an interval period of time of the selected time period; transmitting, via a processor, said plurality of notifications to the primary individual; and determining, via a professor, at least one secondary individual to receive the plurality of notifications; and transforming, via a processor an initial reminder instructions into a transmission of at least one of the plurality of notifications in at least one of the selected time period and continues at the interval period of time.

In some embodiments, the reminders work in conjunction with an individual's mobile device or computing device and in other embodiments the plurality of notifications are comprised of content within at least one of an electronic mail, short message service and voice mail. Preferably, the content of the electronic mail reminds the primary individual and the at least one secondary individual to check that an infant is present within a predetermined space. In some embodiments, the content of the short message service reminds the primary individual and the at least one secondary individual to check that an infant is present within a predetermined space. In other embodiments, the content of the voice mail reminds the primary individual and the at least one secondary individual to check that an infant is present within a predetermined space and/or the predetermined space includes a motorized vehicle. In one preferred embodiment the content of the electronic mail, short message service and voice mail may be customized. In another preferred embodiment the plurality of notifications ceases when the primary individual notifies the system to cease the plurality of notifications.

It is an object of the present invention to provide a means for not forgetting an animal or small child in the car.

It is an object of the present invention to provide a means for preventing the incidence of death in infants.

It is an object of the present invention to provide a redundant system for remembering things.

It is an object of the present invention to provide a system that can contact multiple people in case of a particular event.

It is an object of the present invention to provide a means for notifying a user that an object was left in a place beyond a predetermined period of time.

### BRIEF DESCRIPTION OF THE DRAWINGS

FIG. 1 shows an embodiment of the alarm screen of the present invention.

FIG. 2 shows an embodiment of the alerts preferences screen of the present invention.

FIG. 3 shows an embodiment of the add people screen of the present invention.

FIG. 4 shows an embodiment of the add profile screen of the present invention.

FIG. 5 shows an embodiment of the manage contacts screen of the present invention.

FIG. 6 shows an embodiment of the signup screen of the present invention.

FIG. 7 shows an alternative embodiment of the signup screen of the present invention.

FIG. 8 shows an embodiment of the forgot password screen of the present invention.

FIG. 9 shows an embodiment of the home screen of the present invention.

FIG. 10 shows an embodiment of the profile upload screen of the present invention.

FIG. 11 shows an embodiment of the profile screen of the present invention.

FIG. 12 shows an embodiment of a system of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

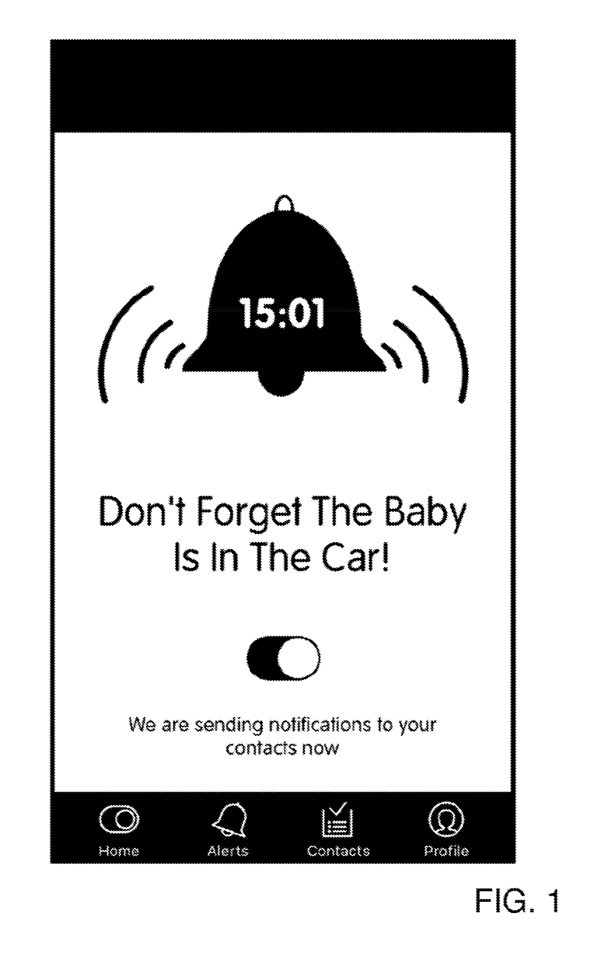

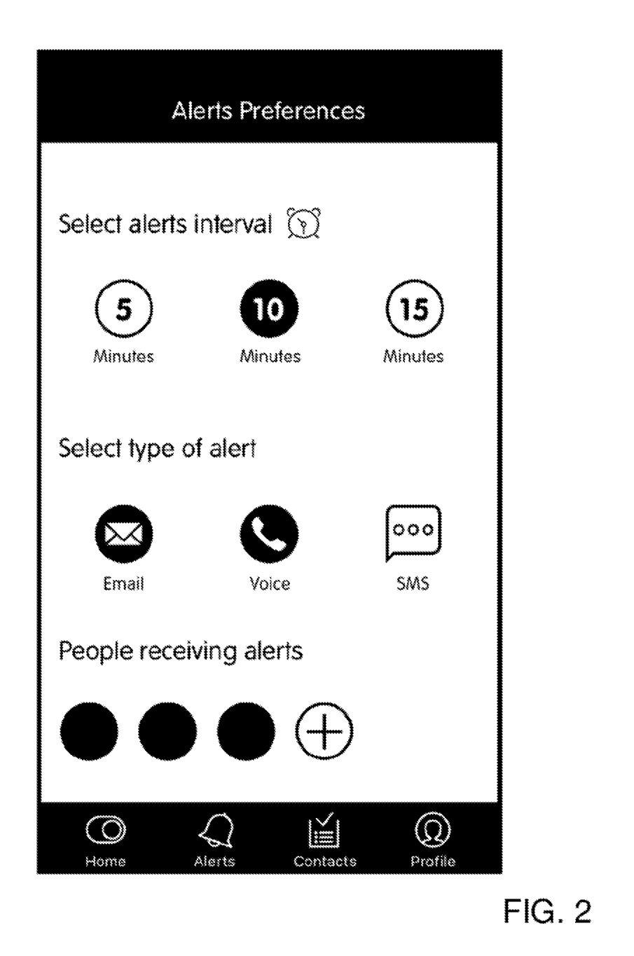

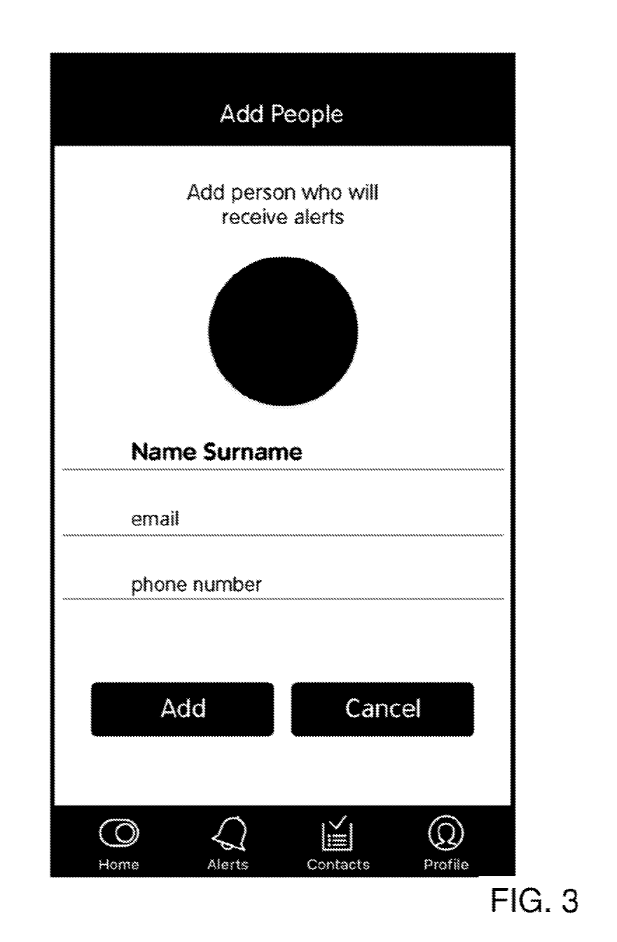

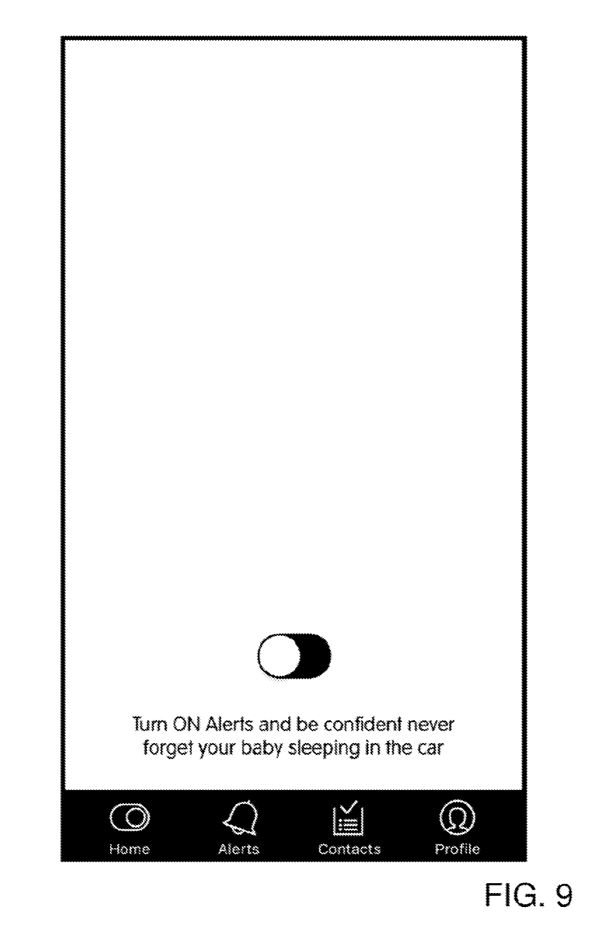

Referring to FIGS. 1-11, embodiments of various screens of the present invention have been shown. Generally, the present invention allows a user to set an alarm with unique properties. Here, as shown in FIG. 2, this alarm not only counts down from a predetermined amount of time, but has a variety of notification options. These notification options allow a user to decide the medium that they would like to be contacted by (as shown in FIG. 2), and allows a user to determine who will be receiving the message. For example, a user can choose to have the present invention email, call, or text a notification. Moreover, this user can choose to have a number of other people receive this message. All the user has to do is enter the contact information for the person who is to receive the notification (as shown in FIG. 3), and indicate that that person is to receive a notification when setting the alarm. According to an embodiment, the user may be able to turn alerts on and/or off (as shown in FIG. 9).

According to an embodiment, the message may be “Don't Forget The Baby Is In The Car!” or similar message. It is noted, however, that other messages may be used while maintaining the spirit of the present invention. In a preferred embodiment, the message that is received in SMS and voice calls is: “Please check your baby-your baby is on board.” However, there exist other preferred embodiments where a user is allowed to customize this message via the interface of the present invention.

In one exemplary embodiment, the present invention allows a user to enter the contact information of at least one other person (as shown in FIG. 3). This information is stored within the memory of the present invention. While the system is capable of storing a variety of contact information, it is preferably optimized to store a contact's email address, home phone number, and cell phone number. At the end of the alarm, the present invention will notify one or more of the stored contacts via a preselected notification method. In another preferred embodiment, the present invention will send two SMS per notification, one voice call per notification, and one email per notification. In an alternative embodiment, a user may customize this further. For example, a user may have 5 SMS be sent per notification, and may have two voice calls be made.

In some embodiments, notifications are sent out via a local number. This will help the recipients save on costs incurred by receiving these notification. In other embodiments, a toll-free number is used. Any public facing email is suitable for use with the present invention.

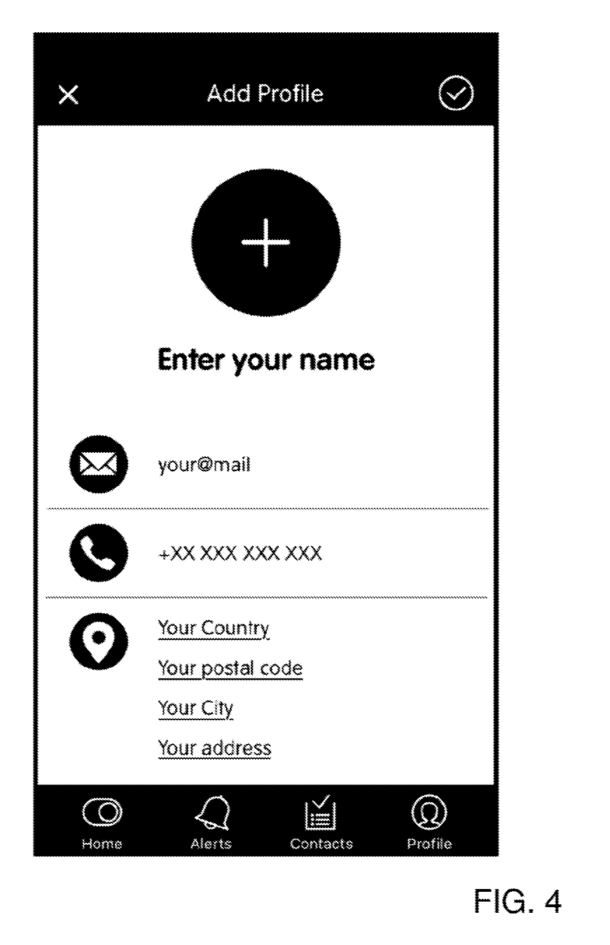

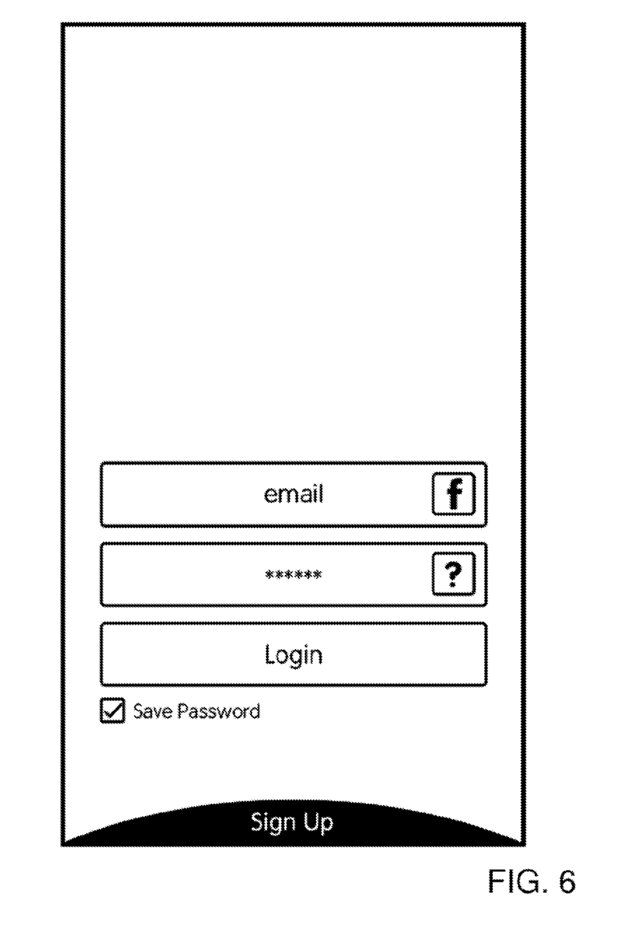

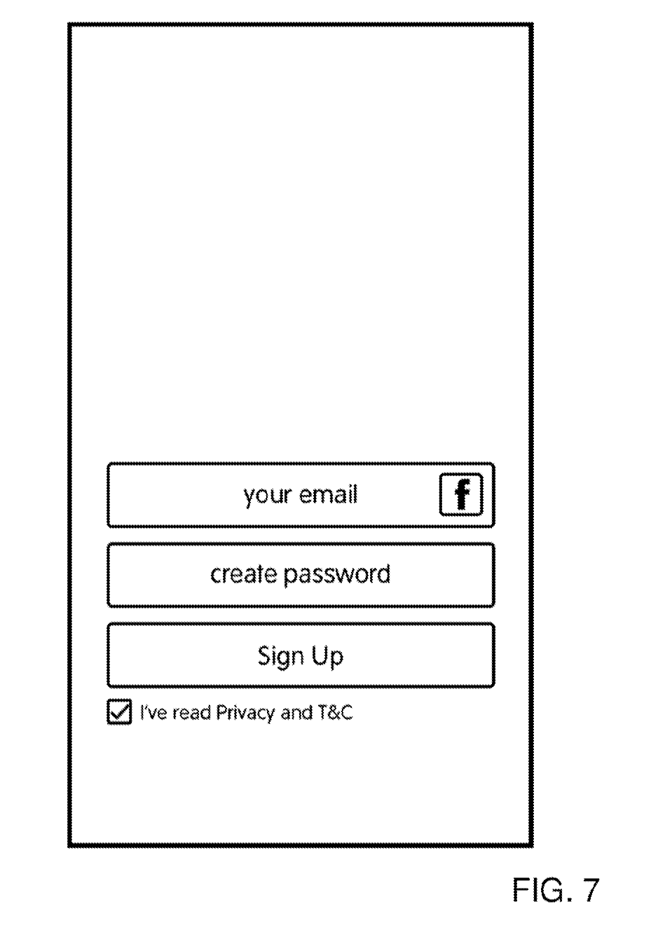

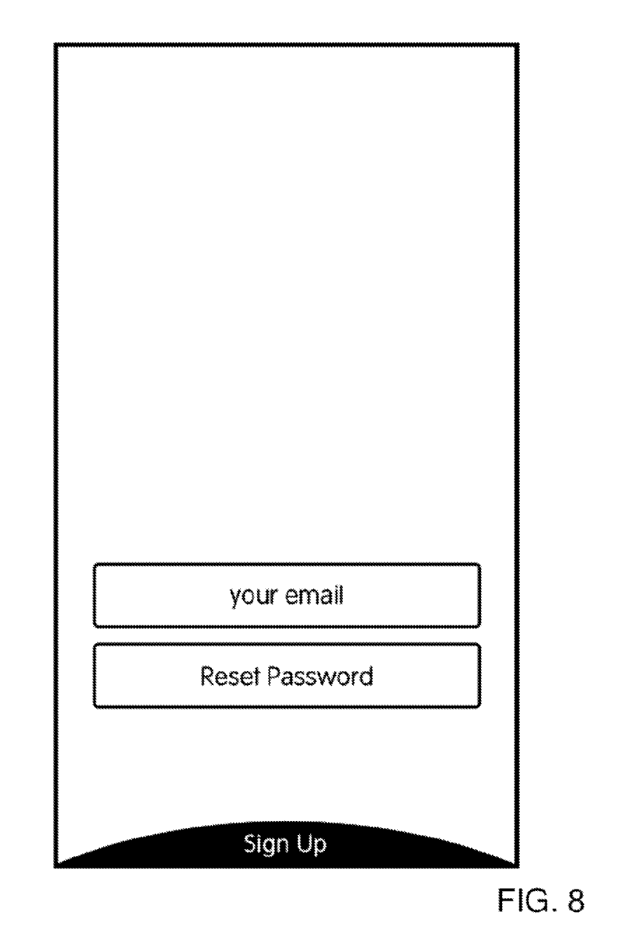

When a user first interacts with a highly proffered embodiment of the present invention, they are prompted to login and/or sign up (as shown in FIG. 6) to set up a user profile (as shown in FIG. 4). According to an embodiment, the user, upon signing up, may (as shown in FIG. 7) may be asked to confirm that the user has read any privacy statements and/or any terms and conditions. If a user forgets the password after signing up, the user may be sent to a password reset screen (as shown in FIG. 8).

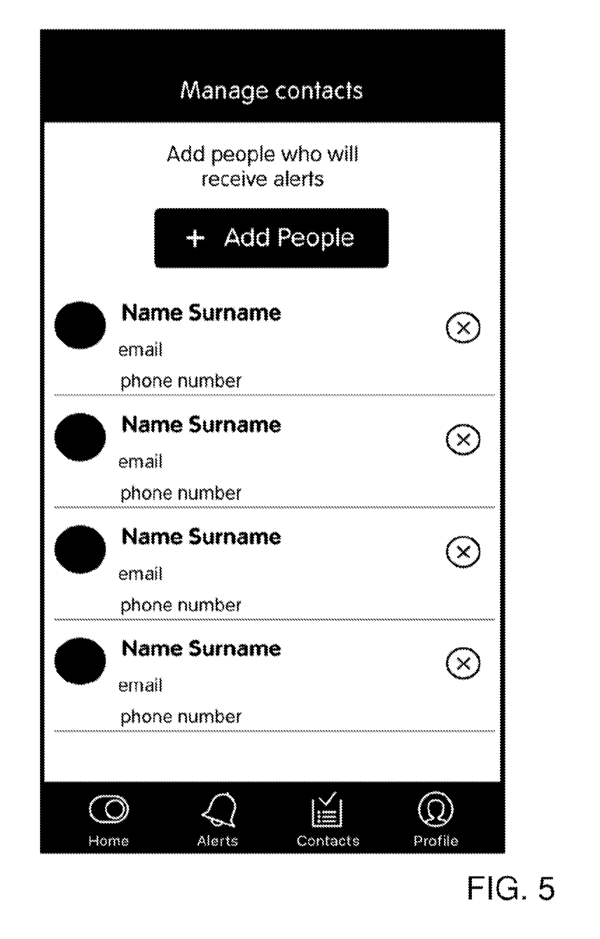

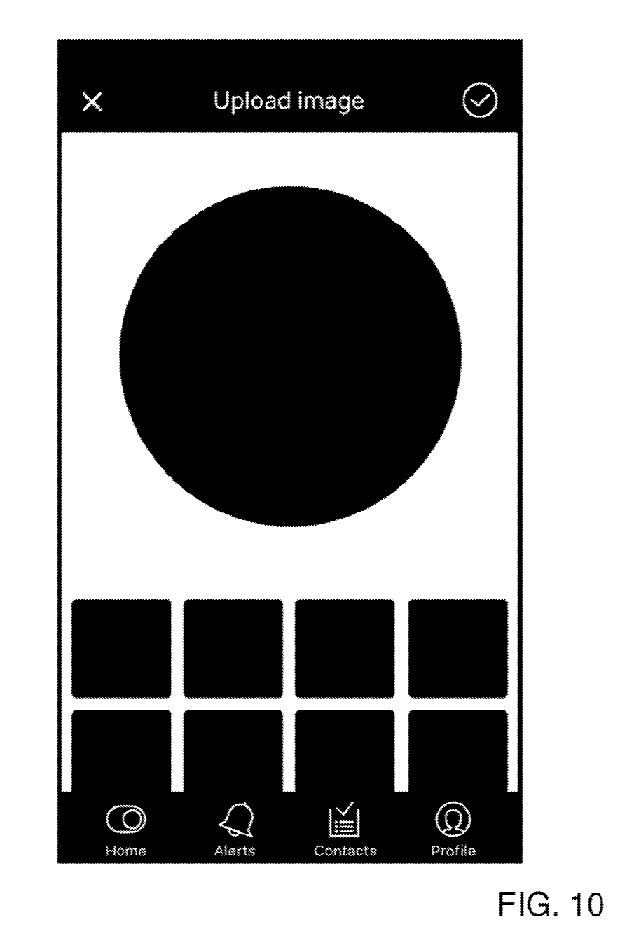

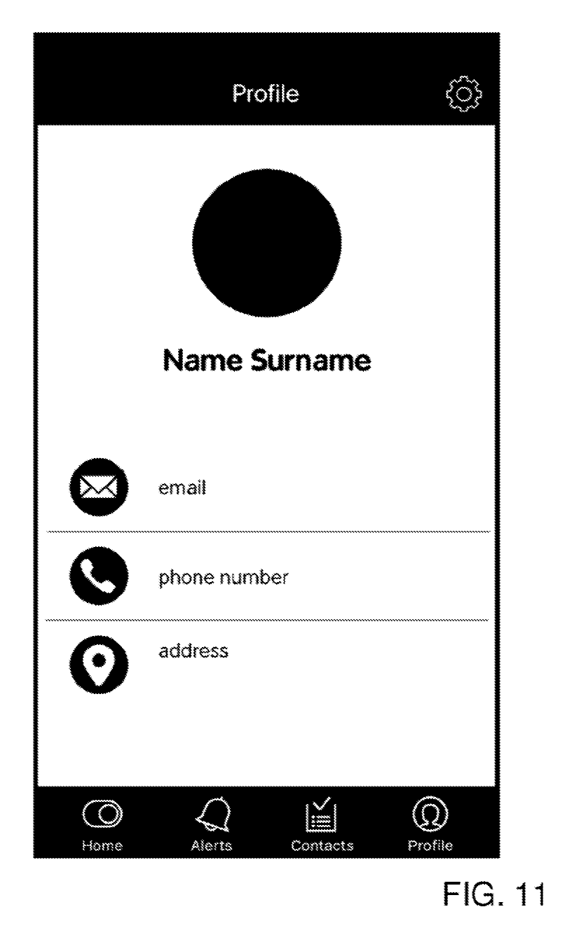

Preferably, this profile contains a user's name, email address, at least one phone number, and at least one home address. According to an embodiment the user is able to upload one or more images to the profile (as shown in FIG. 10). According to an embodiment, the user is able to view one or more views of the profile (as shown in FIG. 11). From there, the user is then prompted to enter the contact information for a potential recipient (as shown in FIG. 3). Each recipient should have a name, surname, email, and phone number associated with them. Once the present invention has been populated with this information, a user may select a recipient from a pre-populated list. According to an embodiment, the user may also may also manage their inputted contacts (as shown in FIG. 5), having the capability to add or delete contacts.

Preferably, a user will start the app when they first get in a car. According to an embodiment, the time that the alarm runs for is determined by the user (as shown in FIG. 2), and should be related to the amount of time a user expects to be in the car. For example, if a user knows that the mall they are going to is 30 minutes away, the user should set the alarm for a period of 30 minutes. That way, the user is reminded upon arriving at their destination that their child is in the car and, if desired, specific contacts of the user are also notified so that the user may receive notifications from other sources. It should be noted that the present invention is not intended for use while a child, infant, or pet is left in the car unattended.

In another preferred embodiment, a user may link at least one social media account with the present invention (as shown in FIGS. 6-7), such that the present invention may import a user's information and some contact information of the user's social media connections.

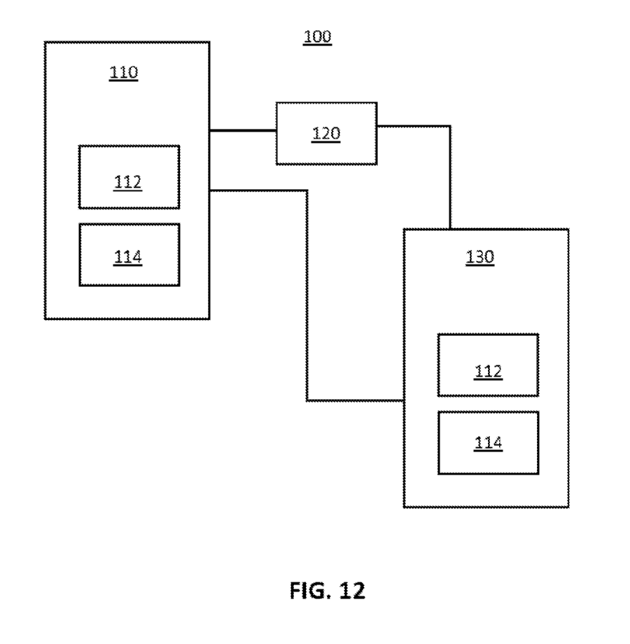

Referring now to FIG. 12, a system 100 of the present invention is illustratively depicted, in accordance with an embodiment of the present invention.

According to an embodiment, the system 100 may include one or more devices (110, 120, 130) to complete one or more of the tasks to be completed according pertaining to the present invention. The system 100 may include an electronic device 110 that includes a processor 112 and a memory 114. The memory 114 may be configured to store contact information, computer-executable instructions, and/or any other relevant data. The processor 112 may be configured to execute one or more instructions stored in the memory 114. The processor 112 may further be configured to process one or more tasks of the present invention.

The electronic device 110 may be coupled to one or more secondary electronic devices 130 (which may each also include a processor 112 and/or a memory 114) and/or an intermediary server 120. The electronic device 110 may be coupled to the server 120 and/or the one or more secondary electronic devices 130 through a wired and/or wireless connection. The electronic device 110 and/or the one or more secondary electronic devices 130 may include a personal computer, a phone, a tablet, a laptop computer, and/or any other suitable electronic device.

Systems, Devices and Operating Systems

Typically, a user or users, which may be people or groups of users and/or other systems, may engage information technology systems (e.g., computers) to facilitate operation of the system and information processing. In turn, computers employ processors to process information and such processors may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the present invention may be connected to and/or communicate with entities such as, but not limited to: one or more users from user input devices; peripheral devices; an optional cryptographic processor device; and/or a communications network. For example, the present invention may be connected to and/or communicate with users, operating client device(s), including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The present invention may be based on computer systems that may comprise, but are not limited to, components such as: a computer systemization connected to memory.

### Computer Systemization

A computer systemization may comprise a clock, central processing unit (“CPU(s)” and/or “processor(s)” (these terms are used interchangeable throughout the disclosure unless noted to the contrary)), a memory (e.g., a read only memory (ROM), a random access memory (RAM), etc.), and/or an interface bus, and most frequently, although not necessarily, are all interconnected and/or communicating through a system bus on one or more (mother)board(s) having conductive and/or otherwise transportive circuit pathways through which instructions (e.g., binary encoded signals) may travel to effect communications, operations, storage, etc. Optionally, the computer systemization may be connected to an internal power source; e.g., optionally the power source may be internal. Optionally, a cryptographic processor and/or transceivers (e.g., ICs) may be connected to the system bus. In another embodiment, the cryptographic processor and/or transceivers may be connected as either internal and/or external peripheral devices via the interface bus I/O. In turn, the transceivers may be connected to antenna(s), thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing the controller of the present invention to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems. The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the present invention and beyond through various interfaces. Should processing requirements dictate a greater amount speed and/or capacity, distributed processors (e.g., Distributed embodiments of the present invention), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the present invention may be achieved by implementing a microcontroller such as CAST's R8051XC2 microcontroller; Intel's MCS 51 (i.e., 8051 microcontroller); and/or the like. Also, to implement certain features of the various embodiments, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the component collection (distributed or otherwise) and/or features of the present invention may be implemented via the microprocessor and/or via embedded components; e.g., via ASIC, coprocessor, DSP, FPGA, and/or the like. Alternately, some implementations of the present invention may be implemented with embedded components that are configured and used to achieve a variety of features or signal processing.

Depending on the particular implementation, the embedded components may include software solutions, hardware solutions, and/or some combination of both hardware/software solutions. For example, features of the present invention discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the features of the present invention. A hierarchy of programmable interconnects allow logic blocks to be interconnected as needed by the system designer/administrator of the present invention, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the present invention may be developed on regular FPGAs and then migrated into a fixed version that more resembles ASIC implementations. Alternate or coordinating implementations may migrate features of the controller of the present invention to a final ASIC instead of or in addition to FPGAs. Depending on the implementation all of the aforementioned embedded components and microprocessors may be considered the “CPU” and/or “processor” for the present invention.

### Power Source

The power source may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell is connected to at least one of the interconnected subsequent components of the present invention thereby providing an electric current to all subsequent components. In one example, the power source is connected to the system bus component. In an alternative embodiment, an outside power source is provided through a connection across the I/O interface. For example, a USB and/or IEEE 1394 connection carries both data and power across the connection and is therefore a suitable source of power.

### Interface Adapters

Interface bus(ses) may accept, connect, and/or communicate to a number of interface adapters, conventionally although not necessarily in the form of adapter cards, such as but not limited to: input output interfaces (I/O), storage interfaces, network interfaces, and/or the like. Optionally, cryptographic processor interfaces similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces may accept, communicate, and/or connect to a number of storage devices such as, but not limited to: storage devices, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like. Network interfaces may accept, communicate, and/or connect to a communications network. Through a communications network, the controller of the present invention is accessible through remote clients (e.g., computers with web browsers) by users. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed embodiments of the present invention), architectures may similarly be employed to pool, load balance, and/or otherwise increase the communicative bandwidth required by the controller of the present invention. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces may be used to engage with various communications network types. For example, multiple network interfaces may be employed to allow for the communication over broadcast, multicast, and/or unicast networks.

Input Output interfaces (I/O) may accept, communicate, and/or connect to user input devices, peripheral devices, cryptographic processor devices, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices often are a type of peripheral device (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices may be external, internal and/or part of the controller of the present invention. Peripheral devices may also include, for example, an antenna, audio devices (e.g., line-in, line-out, microphone input, speakers, etc.), cameras (e.g., still, video, webcam, etc.), drive motors, lighting, video monitors and/or the like.

Cryptographic units such as, but not limited to, microcontrollers, processors, interfaces, and/or devices may be attached, and/or communicate with the controller of the present invention. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory. However, memory is a fungible technology and resource, thus, any number of memory embodiments may be employed in lieu of or in concert with one another. It is to be understood that the controller of the present invention and/or a computer systemization may employ various forms of memory. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory will include ROM, RAM, and a storage device. A storage device may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory may contain a collection of program and/or database components and/or data such as, but not limited to: operating system component(s) (operating system); information server component(s) (information server); user interface component(s) (user interface); Web browser component(s) (Web browser); database(s); mail server component(s); mail client component(s); cryptographic server component(s) (cryptographic server) and/or the like (i.e., collectively a component collection). These components may be stored and accessed from the storage devices and/or from storage devices accessible through an interface bus. Although non-conventional program components such as those in the component collection, typically, are stored in a local storage device, they may also be loaded and/or stored in memory such as: peripheral devices, RAM, remote storage facilities through a communications network, ROM, various forms of memory, and/or the like.

### Operating System

The operating system component is an executable program component facilitating the operation of the controller of the present invention. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millennium/NT/Vista/XP (Server), Palm OS, and/or the like. The operating system may be one specifically optimized to be run on a mobile computing device, such as iOS, Android, Windows Phone, Tizen, Symbian, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the controller of the present invention to communicate with other entities through a communications network. Various communication protocols may be used by the controller of the present invention as a subcarrier transport mechanism for interaction, such as, but not limited to: multicast, TCP/IP, UDP, unicast, and/or the like.

### Information Server

An information server component is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the controller of the present invention based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port, and/or the like. An information server may communicate to and/or with other components in a component collection, including itself, and/or facilities of the like. Most frequently, the information server communicates with the database of the present invention, operating systems, other program components, user interfaces, Web browsers, and/or the like.

Access to the database of the present invention may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the present invention. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the present invention as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millennium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the enabled nodes of the present invention. The combined application may be nugatory on systems employing standard Web browsers.

### Mail Server

A mail server component is a stored program component that is executed by a CPU. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the present invention. Access to the mail of the present invention may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component is a stored program component that is executed by a CPU. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component is a stored program component that is executed by a CPU, cryptographic processor, cryptographic processor interface, cryptographic processor device, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RCS), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the present invention may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the component of the present invention to engage in secure transactions if so desired. The cryptographic component facilitates the secure accessing of resources on the present invention and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The Database of the Present Invention

The database component of the present invention may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the database of the present invention may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component includes several tables. A Users (e.g., operators and physicians) table may include fields such as, but not limited to: user_id, ssn, dob, first_name, last_name, age, state, address_firstline, address_secondline, zipcode, devices_list, contact_info, contact_type, alt_contact_info, alt_contact_type, and/or the like to refer to any type of enterable data or selections discussed herein. The Users table may support and/or track multiple entity accounts. A Clients table may include fields such as, but not limited to: user_id, client_id, client_ip, client_type, client_model, operating_system, os_version, app_installed_flag, and/or the like. An Apps table may include fields such as, but not limited to: app_ID, app_name, app_type, OS_compatibilities_list, version, timestamp, developer_ID, and/or the like. A beverages table including, for example, heat capacities and other useful parameters of different beverages, such as depending on size beverage_name, beverage_size, desired_coolingtemp, cooling_time, favorite_drinker, number_of_beverages, current_beverage_temperature, current_ambient_temperature, and/or the like. A Parameter table may include fields including the foregoing fields, or additional ones such as cool_start_time, cool_preset, cooling_rate, and/or the like. A Cool Routines table may include a plurality of cooling sequences may include fields such as, but not limited to: sequence_type, sequence_id, flow_rate, avg_water_temp, cooling_time, pump_setting, pump_speed, pump_pressure, power_level, temperature_sensor_id_number, temperature_sensor_location, and/or the like.

In one embodiment, user programs may contain various user interface primitives, which may serve to update the platform of the present invention. Also, various accounts may require custom database tables depending upon the environments and the types of clients the system of the present invention may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components. The system of the present invention may be configured to keep track of various settings, inputs, and parameters via database controllers.

While this disclosure refers to exemplary embodiments, it will be understood by those skilled in the art that various changes may be made and equivalents may be substituted for elements thereof without departing from the scope of the disclosure. In addition, many modifications will be appreciated by those skilled in the art to adapt a particular instrument, situation or material to the teachings of the disclosure without departing from the spirit thereof. Therefore, it is intended that the disclosure not be limited to the particular embodiments disclosed.

When introducing elements of the present disclosure or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

What is claimed is:

1. A system for reminding of an infant's presence, comprising:
a memory that stores computer-executable instructions; and
a processor, communicatively coupled to said memory that facilitates execution of the computer-executable instructions, the instructions of which comprise:
receiving, via a processor, an instruction to commence at least one reminder of the infant's presence;
receiving, via a processor, an identity of a primary individual to receive at least one reminder;
wherein the at least one reminder comprises at least one of a plurality of notifications;
receiving, via a processor, at least one of a selected time period to commence the at least one of the plurality of notifications;
receiving, via a processor, an interval period of time of the selected time period;
transmitting, via a processor, said plurality of notifications to the primary individual;
determining, via a professor, at least one secondary individual to receive the plurality of notifications; and
transforming, via a processor, initial reminder instructions into a transmission of at least one of the plurality of notifications in at least one of the selected time period and continues at the interval period of time.

2. The system of claim 1, wherein the reminders work in conjunction with an individual's mobile device or computing device.

3. The system of claim 1, wherein the plurality of notifications are selected from the group consisting of: electronic mail; a short message service; and voice mail.

4. The system of claim 3, wherein the content of the electronic mail, short message service, and voice mail may be customized.

5. The system of claim 1, wherein the content of the electronic mail reminds the primary individual and the at least one secondary individual to check that an infant is present within a predetermined space.

6. The system of claim 1, wherein the content of the short message service reminds the primary individual and the at least one secondary individual to check that an infant is present within a predetermined space.

7. The system of claim 1, wherein the content of the voice mail reminds the primary individual and the at least one secondary individual to check that an infant is present within a predetermined space.

8. The system of claim 7, wherein the predetermined space includes a motorized vehicle.

9. The system of claim 1 wherein the plurality of notifications ceases when the primary individual notifies the system to cease the plurality of notifications.

10. A method for reminding of an infant's presence, comprising:
a memory that stores computer-executable instructions; and
a processor, communicatively coupled to said memory that facilitates execution of the computer-executable instructions, the instructions of which comprise:
receiving, via a processor, an instruction to commence at least one reminder of the infants presence;
receiving, via a processor, an identity of a primary individual to receive at least one reminder;
wherein the at least one reminder comprises at least one of a plurality of notifications;
receiving, via a processor, at least one of a selected time period to commence the at least one of the plurality of notifications;
receiving, via a processor, an interval period of time of the selected time period;
transmitting, via a processor, said plurality of notifications to the primary individual;
determining, via a processor, at least one secondary individual to receive the plurality of notifications; and
transforming, via a processor, initial reminder instructions into a transmission of at least one of the plurality of notifications in at least one of the selected time period and continues at the interval period of time.
